(19) United States
(12) Patent Application Publication
(10) Pub. No.: US 2026/0120069 A1
(43) Pub. Date: Apr. 30, 2026

(54) POS TERMINAL, CONTROL METHOD, AND NON-TRANSITORY RECORDING MEDIUM

(71) Applicant: NEC Corporation, Tokyo (JP)

(72) Inventor: Jun Oana, Tokyo (JP)

(73) Assignee: NEC Corporation, Tokyo (JP)

(21) Appl. No.: 19/333,875

(22) Filed: Sep. 19, 2025

(30) Foreign Application Priority Data
Oct. 30, 2024 (JP) 2024-190285

(51) Int. Cl. G06Q 20/20; G06Q 20/10

(52) U.S. Cl. CPC G06Q 20/208; G06Q 20/102

(57) ABSTRACT

A point of sales (POS) terminal includes, one or more memories storing instructions, and one or more processors configured to execute the instructions to, acquire an image of a placed product, determine whether processing to be executed is settlement processing of the product or decision processing of a delivery size of the product based on the image, and switch to a mode according to a determination result.

This application is based upon and claims the benefit of priority from Japanese Patent Application No. 2024-190285, filed on Oct. 30, 2024, the disclosure of which is incorporated herein in its entirety by reference.

### TECHNICAL FIELD

The present disclosure relates to a point of sales (POS) terminal, a control method, and a program.

### BACKGROUND ART

There may be a POS terminal that identifies a product based on an image obtained by capturing the product to be purchased by a customer and performs settlement processing or the like in the store.

The customer may not only purchase the product at the store but also bring the product to be shipped to the store. In this case, the customer performs a delivery procedure at the store.

JP 2021-076494 A describes a dimension measuring system that measures an outer dimension of a package placed in a housing room and calculates a charge required for delivery.

### SUMMARY

The processing by the POS terminal may be different between the case of performing the product settlement and the case of performing the product delivery procedure.

One object of the present disclosure is to provide a POS terminal or the like capable of performing processing in an appropriate processing mode according to a product.

A POS terminal according to one aspect of the present disclosure includes an acquisition means for acquiring an image of a placed product, a determination means for determining whether processing to be executed is settlement processing of the product or decision processing of a delivery size of the product based on the image, and a control means for switching to a mode according to a determination result.

A control method according to one aspect of the present disclosure includes acquiring an image of a placed product, determining whether processing to be executed is settlement processing of the product or decision processing of a delivery size of the product based on the image, and switching to a mode according to a determination result.

A program according to one aspect of the present disclosure causes a computer to execute acquiring an image of a placed product, determining whether processing to be executed is settlement processing of the product or decision processing of a delivery size of the product based on the image, and switching to a mode according to a determination result.

The program may be stored in a non-transitory computer-readable recording medium.

An example of an effect of the present disclosure is that a customer can easily use a coupon.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a system including a POS terminal;

FIG. 2 is an example of a display screen on which product information of a recommended product is displayed;

FIG. 3 is an example of a display screen on which product information of a recommended product is displayed;

FIG. 4 is an example of a display screen on which product information of a recommended product is displayed;

FIG. 5 is a flowchart illustrating an operation of the POS terminal;

FIG. 6 is a block diagram illustrating an example of a configuration of the POS terminal;

FIG. 7 is a flowchart illustrating an operation of the POS terminal; and

FIG. 8 is a diagram illustrating an example of a hardware configuration of the POS terminal.

### EXAMPLE EMBODIMENT

Hereinafter, example embodiments of the present disclosure will be described in detail with reference to the drawings.

### Example Embodiment

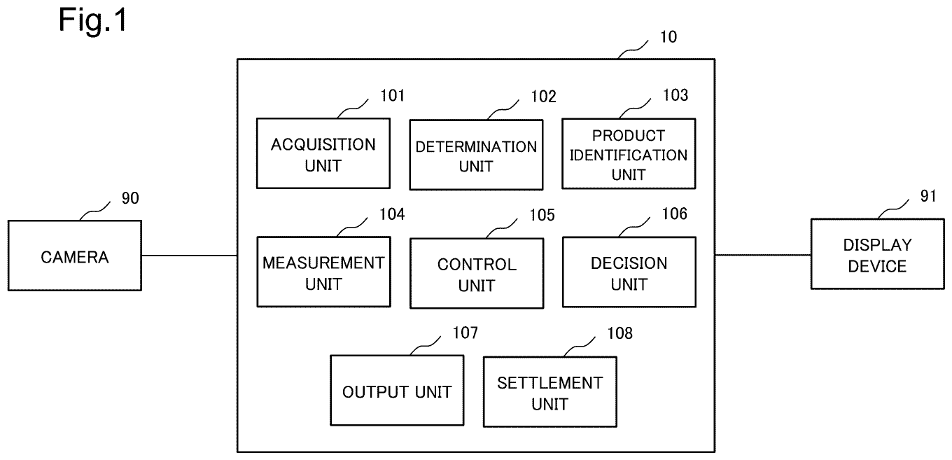

A configuration example of a system including a POS terminal 10 will be described with reference to FIG. 1. FIG. 1 is a diagram illustrating an example of a configuration of a system including the POS terminal 10.

The POS terminal 10 is used in a store. The store is, for example, a convenience store. The example of the store is not limited thereto. The POS terminal 10 is, for example, a device capable of product identification and settlement processing. Here, the product includes a purchased product to be purchased by the customer and a delivery item to be delivered by the customer. The purchased product to be purchased by the customer is a product being sold at a store. The delivery item to be delivered by the customer is a product that the customer brings to the store and is subjected to a delivery procedure. The delivery procedure includes, for example, a procedure in which a salesclerk measures the size of the delivery item. The delivery procedure may include a procedure in which the customer pays a delivery fee. The delivery procedure may include, for example, a procedure in which a customer prepares a waybill for delivery and attaches the waybill to a delivery item.

Referring to FIG. 1, the POS terminal 10 is connected to a camera 90 and a display device 91 via a wired or wireless network.

The camera 90 is an imaging device capable of capturing an image. The customer places the product on a mounting place. The mounting place is, for example, a counter or a stand installed beside the POS terminal 10. The mounting place is not limited thereto. Then, the camera 90 is installed at a position where the mounted product can be imaged. The camera 90 is installed, for example, at a position where the mounting place can be imaged from above. The installation place of the camera 90 is not limited thereto. For example, the camera 90 may be installed at a position where the mounting place can be imaged from the side. Referring to FIG. 1, there is one camera 90 connected to the POS terminal 10. The number of cameras 90 is not limited. A plurality of cameras 90 may be connected to the POS terminal 10. The plurality of cameras may be installed at positions where the mounting place can be imaged from different angles. It is sufficient that a necessary number of cameras 90 are installed at necessary places where a necessary number of cameras are required according to the size of the mounting place or the like.

The display device 91 is a device capable of displaying information regarding a product. The display device 91 is installed at a position where a person using the POS terminal 10 can confirm. For example, in a case where the customer uses POS terminal 10, the customer checks the contents displayed on the display device 91. Therefore, the display device 91 is installed at a position where the customer can confirm the display content. The display device 91 may be built in the POS terminal 10. The display device 91 may be externally attached to the POS terminal 10.

Referring to FIG. 1, there is one display device 91 connected to the POS terminal 10. The number of display devices 91 is not limited. The number of display devices 91 may be one or more. The display device 91 is, for example, a display. The display device 91 may be a tablet terminal or a mobile terminal. The display device 91 is not limited thereto.

A configuration of the POS terminal 10 will be described with reference to FIG. 1. The POS terminal 10 includes an acquisition unit 101, a determination unit 102, a product identification unit 103, a measurement unit 104, a control unit 105, a decision unit 106, an output unit 107, and a settlement unit 108.

The acquisition unit 101 is an aspect of an acquisition means for acquiring an image of a placed product. The acquisition unit 101 acquires an image of the product captured by the camera 90. The acquisition unit 101 may acquire a plurality of images from the camera 90. In a case where a plurality of cameras 90 are installed, the acquisition unit 101 may acquire a plurality of images. In a case where a plurality of cameras 90 are installed, the acquisition unit 101 may acquire images of products captured from different angles. The acquisition unit 101 can acquire a plurality of images captured from different angles, for example, an image of the product captured from above, an image of the product captured from a side surface, an image of the product captured from obliquely above, and the like. The acquisition unit 101 may acquire an image captured by the camera 90 in real time.

For example, the acquisition unit 101 may acquire the image of the product when detecting that the product is placed on the mounting place. The placement of the product may be detected by a change in weight of the product measured by the measurement unit 104 described later. The placement of the product may be detected by the operation of the customer. For example, after the customer places the product, an operation indicating that the product has been placed is performed on the POS terminal 10. The acquisition unit 101 may detect that the product is placed on the mounting place by the operation by the customer. The operation indicating that the product is placed may be an operation for the customer to start using the POS terminal 10. The acquisition unit 101 detects that the product is placed on the mounting place. Then, the acquisition unit 101 may acquire an image of the product captured by the camera 90 at that time. The method of detecting that the product is placed is not limited to these methods.

The determination unit 102 is an aspect of a determination means for determining whether the processing to be executed is the settlement processing of the product or the decision processing of the delivery size of the product based on the image. The settlement processing of the product is a process in which the POS terminal 10 identifies a purchased product and makes a settlement. The customer can purchase the product by making a settlement for the purchased product. The decision processing of the delivery size of the product is a process of deciding the delivery size of the delivery item. The delivery size is a classification of delivery items. The delivery size is used, for example, when a delivery company decides the delivery fee. The delivery size is decided, for example, based on the size of the delivery item. Examples of the delivery size are “size 60”, “size 80”, and “size 100”. These delivery sizes are determined, for example, based on the sum of the lengths of the three sides of the delivery item. In addition, the delivery size is decided based on the weight of the delivery item. For example, the delivery size may be different between a case where the weight of the delivery item is equal to or less than a predetermined weight and a case where the weight of the delivery item is greater than the predetermined weight. The predetermined weight is decided in advance by a delivery company or the like.

A method of determining processing to be executed by the determination unit 102 will be described.

The determination unit 102 can determine processing to be executed based on the type of the product. Here, the type of product is a purchased product to be purchased by a customer and a delivery item to be delivered by the customer. That is, the determination unit 102 can determine the processing to be executed depending on whether the product captured in the image is a purchased product or a delivery item. In a case where the product captured in the image is a purchased product, the determination unit 102 determines that the processing to be executed is the settlement processing of the product. On the other hand, in a case where the product captured in the image is a delivery item, the determination unit 102 determines that the processing to be executed is the decision processing of the delivery size of the product. The type of the product may be identified by the product identification unit 103.

The product identification unit 103 is an aspect of a product identification means for identifying a type of a product based on an image of the product. As described above, the type of the product is a purchased product to be purchased by the customer and a delivery item to be delivered by the customer. The product identification unit 103 can identify whether the product captured in the image is a purchased product or a delivery item based on the image of the product.

An example of an identification method of the type of the product by the product identification unit 103 will be described. The product identification unit 103 analyzes the image of the product acquired by the acquisition unit 101. Then, the product identification unit 103 extracts a feature point of the product captured in the image. The extracted feature points are collated with a product database registered in advance. Then, the product identification unit 103 identifies the type of the product based on the collation result.

In the product database, information indicating feature points of products sold in the store is registered. The information indicating the feature point of the product sold in the store may be information that can specify the classification of the product sold in the store. Examples of the classification are plastic bottles and rice balls. The information indicating the feature point of the product sold in the store may be information that can individually specify the product sold in the store.

The product identification unit 103 collates the feature point of the product captured in the image with the feature point of the product registered in the product database. Then, in a case where the extracted feature point is registered in the product database as a result of the collation, the product identification unit 103 can identify the product captured in the image as the purchased product. On the other hand, in a case where the extracted feature point is not registered in the product database, the product can be identified as the delivery item.

The information stored in the product database is not limited thereto. Information indicating the feature point of the delivery item may be registered in the product database. The product identification unit 103 collates the feature point of the product captured in the image with the feature point of the delivery item registered in the product database. Then, in a case where the extracted feature point is registered in the product database as a result of the collation, the product identification unit 103 can identify the product captured in the image as the delivery item. On the other hand, in a case where the extracted feature point is not registered in the product database, the product can be identified as the delivery item.

An example of an identification method of the type of the product by the product identification unit 103 will be described. The product identification unit 103 may identify the type of the product using the learned image recognition model. The image recognition model is learned using, for example, an image of a product sold in a store. The product identification unit 103 inputs the image of the product acquired by the acquisition unit 101 to the image recognition model. Then, the image recognition model outputs the type of a product captured in the image. The product identification unit 103 acquires information regarding a type of the product as an output of the image recognition model. As a result, the product identification unit 103 can identify the type of the product.

A method of identifying the type of the product by the product identification unit 103 is not limited thereto. The product identification unit 103 may identify the type of the product by combining the above-described identification methods.

The determination unit 102 can determine processing to be executed based on the number of products. In a case where the number of products captured in the image is plural, the determination unit 102 determines that the processing to be executed is the settlement processing of the products. In a case where there is a plurality of delivery items, the customer may perform the delivery procedure one by one. Therefore, in a case where the number of products placed on the mounting place is plural, the products may be purchased products that a customer intends to purchase. Therefore, in a case where the number of products is plural, the determination unit 102 can determine that the processing to be executed is the settlement processing of the products. At this time, the number of products is detected based on the image of the products. The number of products is detected by the product identification unit 103, for example. The product identification unit 103 detects the number of products included in the image. A known object detection technique can be used to detect the number of products.

In a case where the number of products captured in the image is one, the determination unit 102 may further determine processing to be executed based on the weight of the product. In a case where the number of products captured in the image is one and the weight of the product is larger than the weight of any product sold, the determination unit 102 may determine that the processing to be executed is the decision processing of the delivery size of the product. In a case where there is one product placed on the mounting place and the product is heavier than the weight of any product sold in the store, the placed product is a delivery item. The product data including the weight of each product sold in the store is managed in advance. Therefore, the determination unit 102 refers to the product data and compares the weight of the placed product with the weight of each product sold in the store. Then, in a case where the weight of the placed product is larger than the weight of any product sold, the determination unit 102 determines that the processing to be executed is the decision processing of the delivery size of the product. At this time, the weight of the product is measured by the measurement unit 104.

The measurement unit 104 is an aspect of a measurement means for measuring the weight of a product. The measurement unit 104 can measure the weight of the placed product using, for example, a weight sensor installed in the mounting place. The method of measuring the weight of the product is not limited thereto.

In a case where the number of products captured in the image is one and the weight of the product is equal to or less than the weight of any product sold, the determination unit 102 can determine the processing to be executed based on the type of the product.

The determination method of the processing to be executed by the determination unit 102 is not limited thereto. The determination unit 102 may determine processing to be executed by combining the type of the product and the weight of the product. In the store, for example, packing materials for delivery may be sold. Examples of the packing material for delivery include an envelope and a cardboard box for delivery. The packing material for delivery is not limited thereto. At this time, it may be difficult for the product identification unit 103 to identify whether the placed product is a sold packing material or a delivery item using the packing material. Therefore, the determination unit 102 may determine the processing to be executed based on the type of the product and the weight of the product.

The product identification unit 103 identifies the type of the product based on the image of the product. The measurement unit 104 measures the weight of the product. The determination unit 102 compares the weight of the identified product included in the product data with the measured weight of the product. In a case where the difference between the weight of the identified product and the weight of the measured product is equal to or more than a predetermined value, the determination unit 102 determines that the processing to be executed is the decision processing of the delivery size of the product. On the other hand, in a case where the difference between the weight of the identified product and the weight of the measured product is less than the predetermined value, the determination unit 102 determines that the processing to be executed is the settlement processing for the product. Here, the predetermined value is a weight value that can identify whether the placed product is a sold product or a delivery item. The predetermined value is set in advance.

A case where the product is a delivery envelope will be described as an example. At this time, in a case where a difference between the weight of the envelope as a commercially available product and the measured weight is equal to or more than a predetermined value, the envelope may contain contents. That is, the placed product may be a delivery item. The determination unit 102 determines that the processing to be executed is the decision processing of the delivery size of the product. However, in a case where the difference between the weight of the envelope as a commercially available product and the measured weight is less than a predetermined value, the envelope may not contain contents. That is, the placed product may be a product that the customer intends to purchase. Therefore, the determination unit 102 determines that the processing to be executed is the settlement processing of the product.

The control unit 105 is an aspect of a control means for switching to a mode according to a determination result. The control unit 105 switches the operation mode of the POS terminal 10 according to the determination result by the determination unit 102. In a case where the processing to be executed is the decision processing of the delivery size of the product, the control unit 105 switches to a delivery size decision mode. The mode for executing the decision processing of the delivery size of the product is the delivery size decision mode. In a case where the processing to be executed is the settlement processing of a product, the control unit 105 switches to a product identification mode. The mode for executing the settlement processing of the product is the product identification mode.

The delivery size decision mode and the product identification mode will be described.

The decision unit 106 is an aspect of a decision means for deciding the delivery size based on the product image in the delivery size decision mode. The decision unit 106 determines the delivery size based on the image of the product acquired by the acquisition unit 101. The decision unit 106 determines the delivery size based on the size of the product measured from the image of the product. As described above, the delivery size is a classification of delivery items. The delivery size is decided, for example, based on the size of the delivery item. As a specific example, the delivery size is decided based on the sum of the lengths of the three sides of the delivery item. For each delivery size, a reference range of the sum of the lengths of the three sides relevant to the delivery size is decided in advance. Then, the delivery size is decided according to which delivery size reference range the sum of the measured lengths of the three sides belongs to. For example, in the reference range of “size 60”, the sum of the lengths of the three sides is equal to or less than 60 cm, and the reference range of “size 80” is 80 cm. At this time, in a case where the sum of the measured lengths of the three sides of the delivery item is 65 cm, the delivery size of the delivery item is “size 80”. An example of the delivery size reference range is not limited thereto.

The measurement unit 104 measures the size of the product using the image of the product acquired by the acquisition unit 101. The acquisition unit 101 acquires, for example, an image of a product captured by the camera 90 capable of capturing an image of the mounting place from above. Then, the measurement unit 104 can measure the size of the product using the image acquired by the acquisition unit 101. The measurement unit 104 measures the lengths of the three sides of the product as the size of the product. The lengths of the three sides of the product are, for example, the length in the longitudinal direction and the length in the lateral direction of the upper surface of the product placed on the mounting place, and the height of the product. In the image captured by the camera 90 capable of capturing the mounting place from above, the lengths of the three sides of the product are the length in the longitudinal direction and the length in the lateral direction of the upper surface of the product and the length in the depth direction of the product.

A method of measuring the size of a product by the measurement unit 104 will be described. The measurement unit 104 can measure the size of the product using a known image processing technique. For example, a length reference installed in advance is installed in the mounting place. Then, the measurement unit 104 can measure the lengths of the three sides of the product based on the correspondence relationship between the product captured in the image and the length reference. The method of measuring the size of the product is not limited thereto.

The measurement unit 104 may measure the size of the product using the plurality of images acquired by the acquisition unit 101. The POS terminal 10 may be connected to a plurality of cameras 90. The plurality of cameras are installed at positions where the mounting place can be imaged from different angles. Therefore, the measurement unit 104 can measure the size of the product using the images of the product captured from a plurality of angles.

In a case where there is a side whose length is difficult to be measured, the measurement unit 104 may decide to request a change in the placing way of the product. The case where it is difficult to measure the length includes, for example, a case where a part of the product is hidden and a case where the lengths of all sides of the product cannot be measured. The case where it is difficult to measure the length is not limited thereto, and may include a case where a part or all of the product is not included in the range that can be imaged by the camera. In such a case, the measurement unit 104 decides to request the customer to change the placing way of the product. The change in the placing way of the product means that the placing way of the product is changed so that a side that is difficult to measure can be measured. The change in placing way of the product is, for example, rotating the product and moving the position where the product is placed. The rotation of the product includes horizontal rotation and vertical rotation with respect to the mounting place. The change in placing way of the product is not limited thereto. In a case where the measurement unit 104 decides to request the change in placing way of the product, the output unit 107 described later outputs a change request of the placing way of the product. The output of the change request of the placing way will be described later. In a case where the placing way of the product is changed, the acquisition unit 101 acquires a newly captured image of the product. Then, the measurement unit 104 measures the size of the product using the image of the product acquired by the acquisition unit 101.

In a case where there is a side whose length is difficult to be measured, the measurement unit 104 may designate the camera 90 that captures an image of a product. For example, the acquisition unit 101 acquires an image captured by a camera installed at a position where the mounting place can be imaged from above. However, in a case where there is a side where it is difficult to measure the length using the image, the measurement unit 104 may decide to use a camera different from the camera that has captured the image. The measurement unit 104 can designate a camera different from the camera that has captured the image as the camera 90 that captures an image of a product.

For example, the measurement unit 104 specifies a side whose length is difficult to be measured in an image captured by a camera installed at a position where the mounting place can be imaged from above. Then, the measurement unit 104 can decide the camera 90 installed at a position where the specified side can be imaged as a different camera 90. At this time, information regarding the installation positions of all the cameras 90 and the angles at which the mounting place is imaged is registered in advance. The measurement unit 104 can decide the camera 90 capable of imaging a side whose length is difficult to be measured based on the information regarding the installation position and the angle at which the mounting place is imaged. Then, the acquisition unit 101 acquires an image of the product captured by the decided camera 90. The method of deciding the camera is not limited thereto.

In the delivery size decision mode, the decision unit 106 further decides the delivery size based on the weight of the product. The delivery size may be decided based on the sum of the lengths of the three sides of the product and the weight of the product. For each delivery size, the reference range of the sum of the lengths of the three sides and the reference range of the weight of the product relevant to the delivery size are decided in advance. For example, in the “size 60”, the sum of the lengths of three sides of the delivery item is equal to or less than 60 cm, and the weight is equal to or less than 2 kg. Therefore, the decision unit 106 decides, as the delivery size of the delivery item, the delivery size in which the sum of the measured lengths of the three sides of the product and the weight of the product belong to the reference range. An example of the delivery size reference range is not limited thereto.

The measurement unit 104 measures the size of the product. The measurement unit 104 further measures the weight of the product. Then, the decision unit 106 can decide the delivery size based on the size and weight of the product measured by the measurement unit 104.

The output unit 107 is an aspect of an output means for outputting information about the delivery size. The output unit 107 outputs information regarding the delivery size decided by the decision unit 106. The information regarding the delivery size may include the sum of the lengths of the three sides of the product. The information regarding the delivery size may include the weight of the product. The information regarding the delivery size is not limited thereto. The information regarding the delivery size may include, for example, a delivery fee decided by the settlement unit 108 to be described later.

The output unit 107 outputs the information regarding the delivery size to, for example, the display device 91. The display device 91 displays information regarding the delivery size on the screen. As a result, the customer can confirm the decided delivery size via the screen of the display device 91.

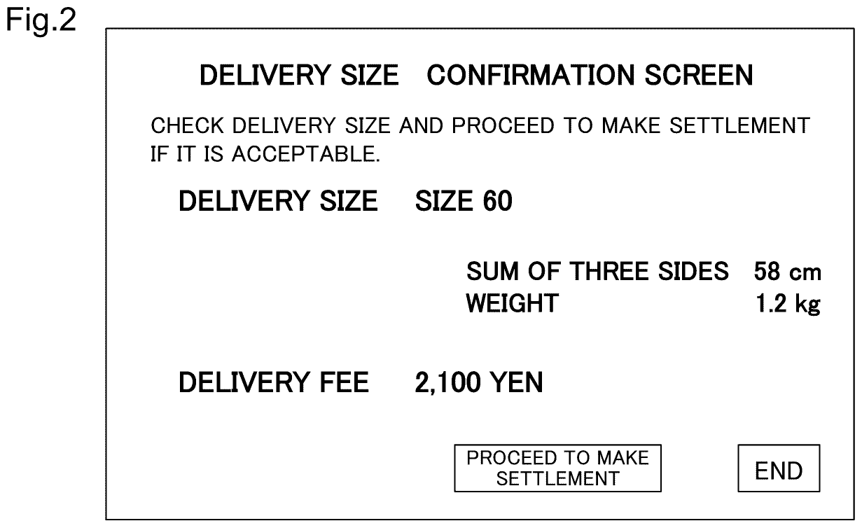

An example of the screen on which information regarding the delivery size is displayed will be described with reference to FIG. 2. FIG. 2 is an example of the screen on which information regarding the delivery size is displayed. Referring to FIG. 2, the delivery size decided by the decision unit 106 is displayed on the screen, and the delivery fee relevant to the delivery size may be displayed on the screen. A method of deciding the delivery fee will be described later. The information displayed on the screen is not limited thereto. For example, an image of a product acquired by the acquisition unit 101 may be displayed on the screen. The size of the product and the weight of the product measured by the measurement unit 104 may be displayed on the screen. The customer can recognize the decided delivery size by viewing the example illustrated in FIG. 2.

The output unit 107 may output the information regarding the delivery size to a voice output device (not illustrated). The output unit 107 may output the information regarding the delivery size to a printing device (not illustrated). For example, the printing device can print information regarding the delivery size. The customer can view a printed material and confirm the delivery size. The output destination of the information regarding the delivery size is not limited thereto.

The output unit 107 may output a screen displaying the delivery size set in advance by the customer and the decided delivery size. For example, the customer may set the delivery size of the delivery item before visiting the store. However, the delivery size set by the customer may be different from the decided delivery size. Therefore, the output unit 107 may output a screen displaying the delivery size set in advance by the customer and the decided delivery size. By outputting a screen displaying the delivery size set in advance by the customer and the decided delivery size, the customer can recognize that the delivery size set in advance is different from the decided delivery size. Even in a case where the delivery size set in advance by the customer is the same as the decided delivery size, the output unit 107 may output a screen displaying the delivery size set in advance by the customer and the decided delivery size.

Here, the delivery size set in advance by the customer is acquired by the acquisition unit 101. The acquisition unit 101 can acquire the delivery size set in advance by the customer by the input of the customer. For example, the customer can input the delivery size using a touch panel of the display device 91. The acquisition unit 101 can acquire information regarding the delivery size set in advance by the customer from a barcode or a two-dimensional code. In a case where the customer uses a flea market service or the like, the customer may set the delivery size in advance through the flea market service. Then, in the flea market service, a barcode or a two-dimensional code including information regarding a delivery size may be generated. Therefore, the acquisition unit 101 can acquire the information regarding the delivery size set in advance by the customer by reading the barcode or the two-dimensional code. The method of acquiring the delivery size set in advance by the customer is not limited thereto.

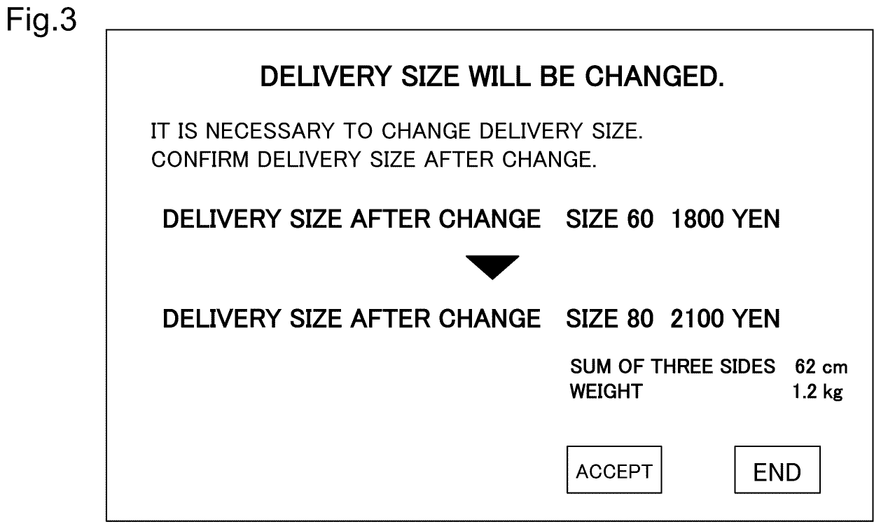

In a case where the delivery size set by the customer is different from the decided delivery size, the output unit 107 may cause the display device 91 to display a screen requesting acceptance of the change in the delivery size. FIG. 3 is an example of a screen for requesting acceptance of the delivery size change. Referring to FIG. 3, the delivery size set by the customer and the decided delivery size are displayed on the screen requesting acceptance of the change in the delivery size. The screen requesting the acceptance of the change in the delivery size displays the delivery fee for the delivery size set by the customer and the delivery fee for the decided delivery size. Then, an accept button for accepting the change is displayed on the screen for requesting acceptance of the delivery size change. When the customer presses the accept button, the delivery size is changed.

The contents displayed on the screen requesting acceptance of the delivery size change are not limited thereto. The screen requesting acceptance of the change in the delivery size may display a difference between the delivery fee for the delivery size set by the customer and the delivery fee for the decided delivery size. A reject button for rejecting the change in the delivery size may be displayed on the screen for requesting acceptance of the change in the delivery size. An end button for ending the operation of the POS terminal 10 may be displayed on the screen requesting acceptance of the change in the delivery size. In a case where the reject button or the end button is pressed, the delivery size may not be changed from the delivery size set by the customer.

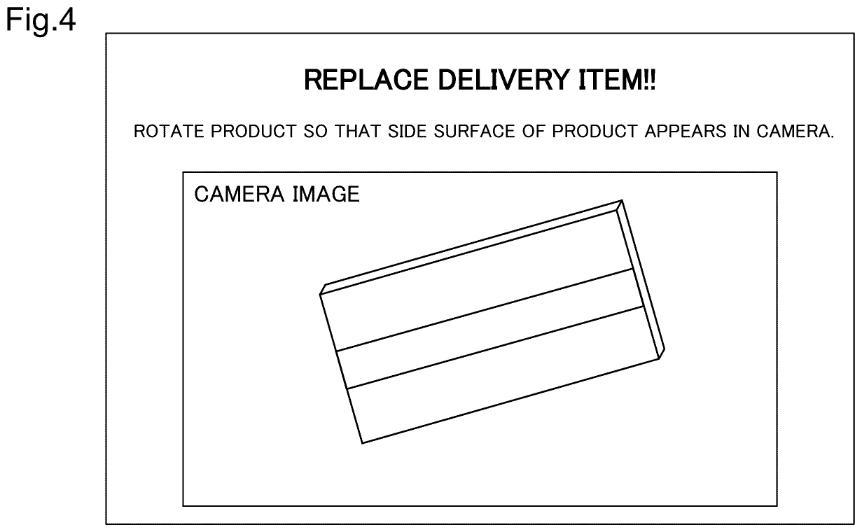

In a case where the measurement unit 104 decides to request the change in the placing way of the product, the output unit 107 may output the change request of the placing way of the product. The output unit 107 may cause the display device 91 to display a screen requesting the customer to change the placing way of the product. FIG. 4 is an example of a screen for requesting a change in the placing way of a product. An image of the product acquired by the acquisition unit 101 is displayed on the screen requesting the change in the placing way of the product. Then, on the screen requesting the change in the placing way of the product, an instruction indicating how to change the placing way of the product is displayed to the customer. In the example illustrated in FIG. 4, the customer is requested to rotate the product to stand it upright again. The information displayed on the screen requesting the change in the placing way of the product is not limited thereto.

In a case where the purchased product and the delivery item are placed on the mounting place, the output unit 107 may output an instruction to place one of the purchased product and the delivery item to the customer. In a case where the products include the purchased product and the delivery item when the determination unit 102 determines the types of the products, the output unit 107 outputs an instruction to place either the purchased product or the delivery item. For example, the output unit 107 can display an instruction to place either the purchased product or the delivery item on the screen of the display device 91. The customer can view a screen on which an instruction to place either the purchased product or the delivery item is displayed. Then, the customer places the purchased product or the delivery item on the mounting place. Then, the acquisition unit 101 newly acquires an image of a product. At this time, the product is a purchased product or a delivery item placed by the customer.

The output unit 107 may cause a waybill used for delivery of the delivery item to be printed. The waybill is a printed matter on which information necessary for delivery is printed. The information necessary for delivery includes, for example, a delivery destination address, a delivery source address, and a delivery size. The information necessary for delivery may include the weight of the product. The information necessary for delivery is not limited thereto. In the waybill, a barcode or a two-dimensional code associated with the delivery destination address, the delivery source address, and the delivery size may be printed. The delivery size printed in the waybill is the delivery size decided by the decision unit 106.

The output unit 107 outputs information necessary for delivery to, for example, a printing device. The printing device prints a waybill including at least part of information necessary for delivery. The waybill is attached to, for example, a delivery item.

The settlement unit 108 is an aspect of a settlement means for performing the settlement processing of the delivery fee according to the delivery size. The settlement unit 108 determines the delivery fee relevant to the delivery size decided by the decision unit 106. Then, the settlement unit 108 executes the settlement processing for the delivery fee. The information regarding the decided delivery fee may be output to the display device 91 by the output unit 107. The customer can confirm the delivery fee displayed on the screen of the display device 91.

Here, the delivery fee relevant to the delivery size is set in advance. For example, the settlement unit 108 refers to a delivery fee list in which the delivery size and the delivery fee are associated with each other, and decides the delivery fee. The delivery fee list may include delivery fees for multiple delivery companies. The delivery fee may vary depending on the delivery distance. The delivery distance is a distance between the delivery source and the delivery destination. The delivery destination and the delivery source may be an address or an area. In the delivery fee list, a delivery fee relevant to the delivery distance may be set. The delivery fee included in the delivery fee list is not limited thereto.

When determining the delivery fee relevant to the delivery size, the settlement unit 108 may request the customer to designate the delivery company. At this time, the output unit 107 may output, to the display device 91, a screen for requesting the customer to designate the delivery company. The settlement unit 108 can decide the delivery fee relevant to the delivery size at the delivery company designated by the customer. The settlement unit 108 may request the customer to designate the delivery destination. At this time, the output unit 107 may output, to the display device 91, a screen for requesting the customer to designate the delivery destination. The settlement unit 108 can determine the delivery fee relevant to the delivery size based on the distance between the delivery source and the delivery destination designated by the customer. The settlement unit 108 may request the customer to designate the delivery distance. At this time, the output unit 107 may output, to the display device 91, a screen for requesting the customer to designate the delivery distance. The settlement unit 108 may determine the delivery fee relevant to the delivery size based on the delivery distance. The method of requesting designation of the delivery company, the delivery destination, or the delivery distance and the acceptance method are not limited thereto. The method of determining the delivery fee is not limited thereto.

The settlement unit 108 executes the settlement processing for the decided delivery fee. The settlement method includes cash and a credit card. This includes electronic money and code settlement. The settlement method is not limited thereto, and a known settlement method is used. As the settlement method, for example, points or coupons of a store may be used. The customer can make a settlement for the delivery fee by a desired settlement method. For example, the output unit 107 may output a screen requesting the customer to select a settlement method to the display device 91. The customer can select a settlement method for actually making a settlement from the settlement method options displayed on the screen of the display device 91. The settlement unit 108 can perform settlement processing by the settlement method selected by the customer.

Here, switching of the mode by the control unit 105 will be described again.

In a case where the processing to be executed is the settlement processing of the product, the control unit 105 switches to the product identification mode. The mode for executing the settlement processing of the product is the product identification mode. In the product identification mode, the POS terminal 10 identifies a purchased product to be purchased by the customer, and performs the settlement processing on the purchased product. In the product identification mode, the customer can make a settlement for the purchased product to be purchased.

The product identification unit 103 identifies a product based on an image of the product. In the product identification mode, the product is a purchased product that the customer intends to purchase. Therefore, the product identification unit 103 identifies the purchased product. In a case where there are a plurality of purchased products, the product identification unit 103 specifies each purchased product. As a method of specifying the purchased product, the above-described method can be used. For example, the product identification unit 103 extracts a feature point of a product from an image of the product. Then, the product identification unit 103 can specify the purchased product with reference to the product database. In addition, the product identification unit 103 may specify a purchased product by using an image recognition model learned for a product sold in a store. The method of specifying the product by the product identification unit 103 is not limited thereto. In a case where the product identification unit 103 specifies an individual product when determining the processing to be executed by the determination unit 102, a specification result by the product identification unit 103 may be used in the product identification mode.

The output unit 107 outputs information regarding the specified purchased product. The information regarding the purchased product includes a product name, a price, and the number of products. The output unit 107 can output the information regarding the purchased product to the display device 91. The customer can confirm the information regarding the purchased product displayed on the display device 91.

The settlement unit 108 performs settlement processing for the purchased product. The settlement processing is performed on the total amount of the purchased products. The settlement processing is as described above. At this time, the output unit 107 may output the information regarding the settlement to, for example, the display device 91.

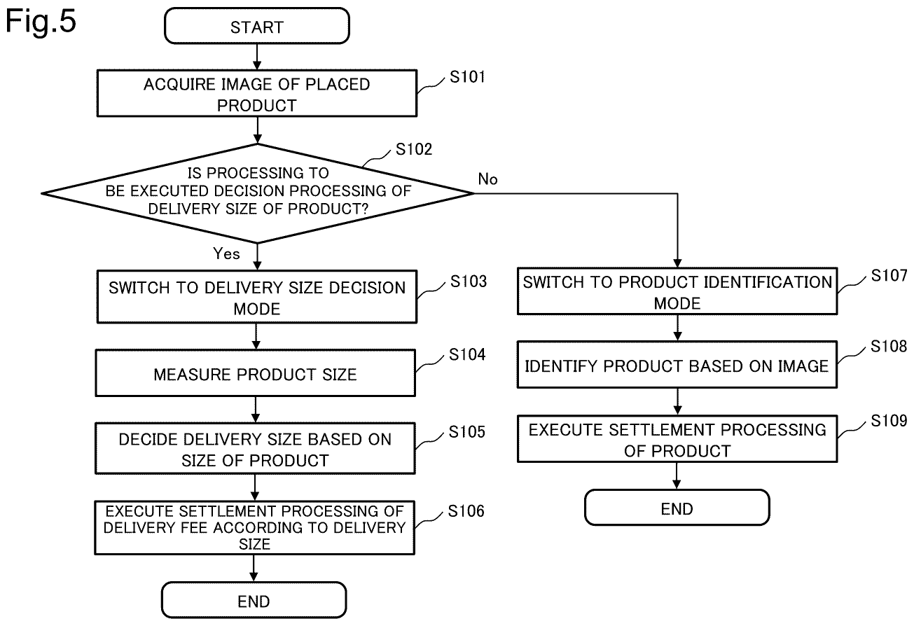

The operation of the POS terminal 10 including the acquisition unit 101, the determination unit 102, the product identification unit 103, the measurement unit 104, the control unit 105, the decision unit 106, the output unit 107, and the settlement unit 108 will be described with reference to FIG. 5. FIG. 5 is a flowchart illustrating an example of the operation of the POS terminal 10. First, in step S101, the acquisition unit 101 acquires an image of a placed product. In step S102, the determination unit 102 determines whether the processing to be executed is the decision processing of the delivery size of the product based on the image. That is, the determination unit 102 determines whether the processing to be executed is the settlement processing of the product or the decision processing of the product delivery size based on the image.

In the case of Yes in step S102, the control unit 105 switches to the delivery size decision mode in step S103. Then, in step S104, the measurement unit 104 measures the size of the product using the image of the product. In step S105, the decision unit 106 decides the delivery size based on the size of the product. In step S106, the settlement unit 108 executes the settlement processing for the delivery fee according to the delivery size. Then, the POS terminal 10 terminates the operation.

In the case of No in step S102, the control unit 105 switches to the product identification mode in step S107. Then, in step S108, the product identification unit 103 identifies the type of the product based on the image of the product. In step S109, the settlement unit 108 executes settlement processing of the product. Then, the POS terminal 10 terminates the operation.

In the present example embodiment, the POS terminal 10 determines whether the processing to be executed by the determination unit 102 is the settlement processing of the product or the decision processing of the delivery size of the product based on the image of the product. Then, the control unit 105 switches to a mode according to the determination result. In a case where the processing to be executed is the decision processing of the delivery size of the product, the control unit 105 switches to a delivery size decision mode. In a case where the processing to be executed is the settlement processing of a product, the control unit 105 switches to a product identification mode. The processing by the POS terminal 10 may be different between the case of performing the product settlement and the case of performing the product delivery procedure. Therefore, the configuration of the POS terminal 10 makes it possible to perform processing in an appropriate operation mode according to the product.

In a store, the customer may not only purchase the product at the store but also bring the product to be shipped to the store. In this case, since the customer performs the delivery procedure in the store, the salesclerk of the store may handle the delivery procedure. Here, there may be a POS terminal 10 that identifies a product based on an image obtained by capturing the product to be purchased by a customer and performs settlement processing or the like in the store. Therefore, in the POS terminal 10, the decision processing of the delivery size of the product is performed, so that it is possible to reduce the time and effort for the salesclerk to perform the delivery procedure. At this time, when the customer places the product on the mounting place, the mode of the POS terminal 10 is switched to an appropriate mode, so that it is also possible to reduce the time and effort of the customer. In the POS terminal 10, the determination unit 102 determines processing to be executed based on the image of the product, and the control unit 105 switches to a mode according to the determination result. With the configuration of the POS terminal 10, it is possible to perform processing in an appropriate processing mode relevant to the product. As a result, for example, even if the customer does not perform an operation such as mode selection, the processing is performed in an appropriate mode. As a result, customer convenience can be improved.

In the present example embodiment, in the POS terminal 10, the determination unit 102 determines processing to be executed based on the type of the product. The type of product is a purchased product to be purchased by a customer and a delivery item to be delivered by the customer. The processing by the POS terminal 10 may be different between the case of making a settlement for the purchased product and the case of performing the delivery procedure for the delivery item. Therefore, the determination unit 102 determines the processing to be executed based on the type of the product, whereby the POS terminal 10 can perform the processing in an appropriate processing mode according to the product.

In the POS terminal 10, the product identification unit 103 identifies the type of the product based on the image of the product. When the customer places the product on the mounting place, the camera 90 captures an image of the product. Then, the acquisition unit 101 acquires an image of the product placed on the mounting place. The determination unit 102 determines processing to be executed based on the image of the product. Therefore, for example, even if the customer does not perform an operation such as mode selection, the processing is performed in an appropriate mode, so that the time and effort of the customer can be reduced.

In the present example embodiment, in the POS terminal 10, the measurement unit 104 measures the weight of the product, and the determination unit 102 determines the processing to be executed based on the type and weight of the product. In the store, for example, packing materials for delivery may be sold. At this time, it may be difficult for the product identification unit 103 to identify whether the placed product is a sold packing material or a delivery item using the packing material. That is, it may be difficult for the product identification unit 103 to identify the type of the product. Therefore, the determination unit 102 determines the processing to be executed based on the type of the product and the weight of the product, whereby the accuracy of the determination can be improved.

In the present example embodiment, in the POS terminal 10, the measurement unit 104 measures the size of the product based on the image of the product, and the decision unit 106 decides the delivery size based on the size of the product. The delivery size is decided, for example, based on the size of the delivery item. As a specific example, the delivery size is decided based on the sum of the lengths of the three sides of the delivery item. Therefore, the measurement unit 104 measures the size of the product using the image of the product acquired by the acquisition unit 101. Then, the decision unit 106 decides the delivery size based on the size of the product, whereby an appropriate delivery size can be decided. Since the delivery size is determined based on the image of the product, for example, there is a case where the salesclerk does not need to measure the size of the delivery item. That is, it is possible to reduce the time and effort of the delivery procedure by the salesclerk.

In the present example embodiment, in the POS terminal 10, the decision unit 106 decides the delivery size based on the size and weight of the product. The delivery size may be decided based on the size of the product and the weight of the product. For example, for each delivery size, the reference range of the sum of the lengths of the three sides and the reference range of the weight of the product relevant to the delivery size are decided in advance. Therefore, the measurement unit 104 measures the size and weight of the product, and the decision unit 106 decides the delivery size based on the size and weight of the product, whereby the appropriate delivery size can be decided. For example, the salesclerk may not need to measure the size and weight of the delivery item. That is, it is possible to reduce the time and effort of the delivery procedure by the salesclerk.

In the present example embodiment, in the POS terminal 10, the settlement unit 108 performs settlement processing of the delivery fee according to the delivery size. In a case where a customer brings a delivery item to a store, the customer may pay a delivery fee at the store. At this time, the salesclerk may pay the delivery fee. However, when the settlement unit 108 performs the settlement processing for the delivery fee relevant to the delivery size, the salesclerk may not be required to take action. That is, it is possible to reduce the time and effort of the delivery procedure by the salesclerk.

In the present example embodiment, in the POS terminal 10, the output unit 107 outputs information regarding the delivery size. The delivery fee may vary depending on the delivery size. Therefore, the customer may want to know the decided delivery size. Therefore, the output unit 107 outputs the information regarding the delivery size to, for example, the display device 91, the voice output device, or the printing device. Since the output unit 107 outputs the information regarding the delivery size, the customer can know the delivery size.

### Second Example Embodiment

A second example embodiment will be described in detail with reference to the drawings. Hereinafter, duplicated contents with the above description will not be described to the extent that the description of the present example embodiment is not unclear.

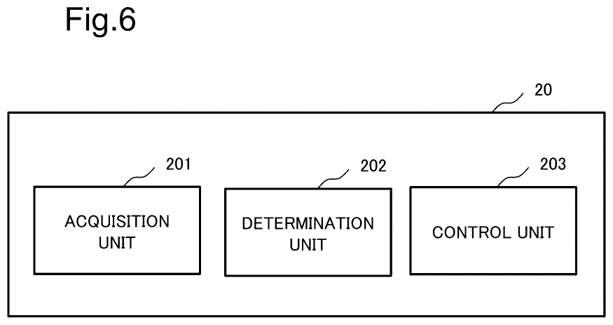

A configuration of a POS terminal 20 will be described with reference to FIG. 6. FIG. 6 is a block diagram illustrating an example of a configuration of the POS terminal 20. The POS terminal 20 includes an acquisition unit 201, a determination unit 202, and a control unit 203.

The acquisition unit 201 is an aspect of an acquisition means for acquiring an image of a placed product. The acquisition unit 201 acquires an image of the product captured by the camera 90.

The determination unit 202 is an aspect of a determination means for determining whether the processing to be executed is the settlement processing of the product or the decision processing of the delivery size of the product based on the image. The settlement processing of the product is a process in which the POS terminal 20 identifies a purchased product and makes a settlement. The decision processing of the delivery size of the product is a process of deciding the delivery size of the delivery item.

The determination unit 202 can determine processing to be executed based on the type of the product. The determination unit 202 may determine processing to be executed based on the number of products. Furthermore, the determination unit 202 can determine processing to be executed based on the weight of the product. The determination method of the processing to be executed by the determination unit 202 is not limited thereto. The determination unit 202 may determine processing to be executed by combining the type of the product and the weight of the product.

The control unit 203 is an aspect of a control means for switching to a mode according to a determination result. The control unit 203 switches the operation mode of the POS terminal 20 according to the determination result by the determination unit 202. In a case where the processing to be executed is the decision processing of the delivery size of the product, the control unit 203 switches to a delivery size decision mode. The mode for executing the decision processing of the delivery size of the product is the delivery size decision mode. In a case where the processing to be executed is the settlement processing of a product, the control unit 203 switches to a product identification mode. The mode for executing the settlement processing of the product is the product identification mode.

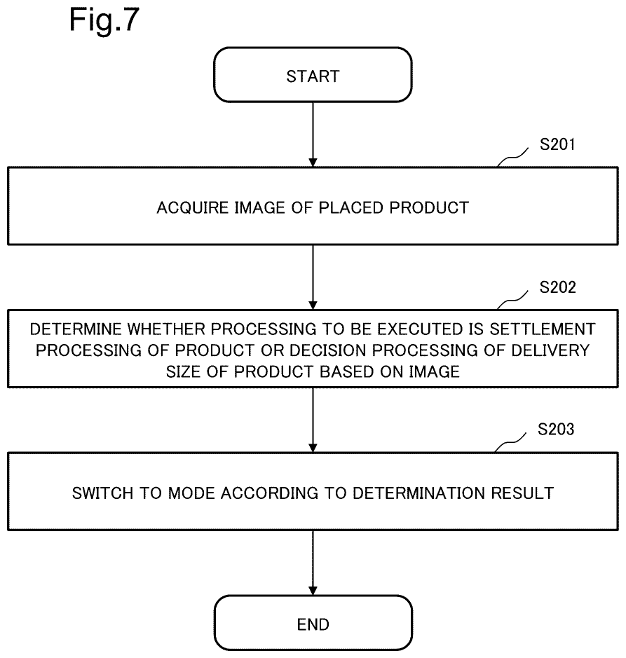

The operation of the POS terminal 20 including the acquisition unit 201, the determination unit 202, and the control unit 203 will be described with reference to FIG. 7. FIG. 7 is a flowchart illustrating an operation of the POS terminal 20. First, in step S101, the acquisition unit 201 acquires an image of a placed product. In step S102, the determination unit 202 determines whether the processing to be executed is the decision processing of the delivery size of the product based on the image. That is, the determination unit 202 determines whether the processing to be executed is the settlement processing of the product or the decision processing of the product delivery size based on the image. Then, in step S203, the control unit 203 switches to a mode according to the determination result. Then, the POS terminal 20 terminates the operation.

In the present example embodiment, the POS terminal 20 determines whether the processing to be executed by the determination unit 202 is the settlement processing of the product or the decision processing of the delivery size of the product based on the image of the product. Then, the control unit 203 switches to a mode according to the determination result. In a case where the processing to be executed is the decision processing of the delivery size of the product, the control unit 203 switches to a delivery size decision mode. In a case where the processing to be executed is the settlement processing of a product, the control unit 203 switches to a product identification mode. The processing by the POS terminal 20 may be different between the case of performing the product settlement and the case of performing the product delivery procedure. Therefore, the configuration of the POS terminal 20 makes it possible to perform processing in an appropriate operation mode according to the product.

### Hardware Configuration Example

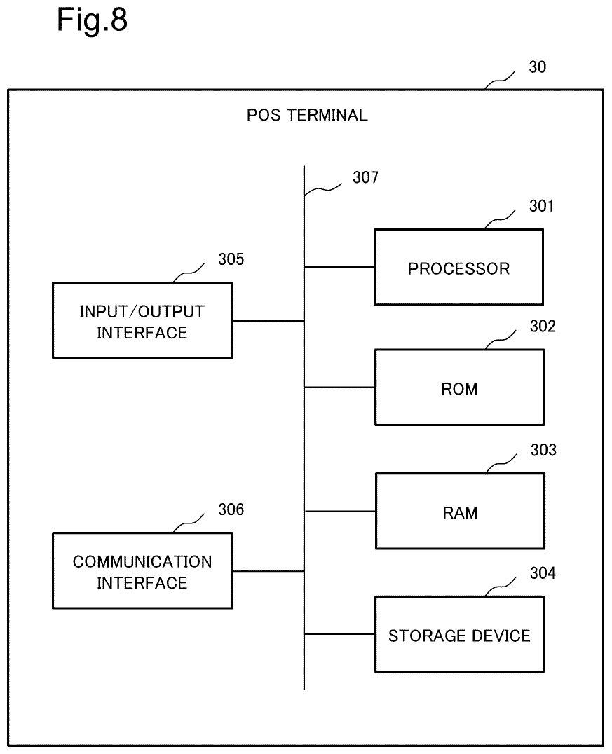

FIG. 8 is a diagram illustrating a hardware configuration example of a POS terminal 30 according to the present disclosure. The POS terminal 30 is implemented by a computer. The POS terminal 30 is an example in a case where the POS terminal 10 or the POS terminal 20 is implemented by a computer.

The POS terminal 30 includes a processor 301, a read only memory (ROM) 302, a random access memory (RAM) 303, a storage device 304 such as a hard disk for storing programs, an input/output interface 305 for inputting/outputting data, and a communication interface 306 for network connection. The components are connected via a bus 307.

The processor 301 operates an operating system to control the entire computer. Examples of the processor 301 include a central processing unit (CPU), a digital signal processor (DSP), and a graphics processing unit (GPU). The processor 301 loads a program stored in, for example, the ROM 302, the storage device 304, or the like. The processor 301 executes each process coded in the program. The processor 301 may execute processing or instructions in the illustrated flowchart based on a program.

The ROM 302 stores an application program, a program according to each example embodiment, and the like. The RAM 303 is used as a work area of the processor 301.

Examples of the storage device 304 include a semiconductor memory such as a flash memory, a hard disk drive (HDD), and the like. The storage device 304 stores, for example, an operating system (OS) program, an application program, a program according to each example embodiment, and the like.

The input/output interface 305 is connected to a peripheral device (not illustrated). The connection method may be a wired network or a wireless network.

The communication interface 306 is connected to a communication network (not illustrated) such as a local network (LAN) or a wide area network (WAN) through a wireless or wired network. The communication network may include a plurality of communication networks. As a result, the computer is connected to an external device via the communication network. The POS terminal 30 may have components other than those illustrated in FIG. 8. For example, the POS terminal 30 may include a drive device or the like. For example, the processor 301 may be mounted on a drive device or the like, and may read a program or data stored in a non-transitory tangible recording medium into the RAM 303.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments can also be described as the following Supplementary Notes, but are not limited to the following.

### Supplementary Note 1

A point of sales (POS) terminal including:
an acquisition means for acquiring an image of a placed product;
a determination means for determining whether processing to be executed is settlement processing of the product or decision processing of a delivery size of the product based on the image; and
a control means for switching to a mode according to a determination result.

### Supplementary Note 2

The POS terminal according to Supplementary Note 1,
further including a product identification means identifying a type of the product based on the image,
in which the determination means determines the processing based on the type.

### Supplementary Note 3

The POS terminal according to Supplementary Note 2,
further including a measurement means for measuring a weight of the product,
in which the determination means determines the processing based on the weight.

### Supplementary Note 4

The POS terminal according to any one of Supplementary Notes 1 to 3, in which
the control means switches to a delivery size decision mode in a case where the processing is decision processing of a delivery size of the product.

### Supplementary Note 5

The POS terminal according to Supplementary Note 4, further including:
a measurement means for measuring a size of the product based on the image; and
a decision means for deciding the delivery size based on the size in the delivery size decision mode.

### Supplementary Note 6

The POS terminal according to Supplementary Note 5, in which
the measurement means further measures a weight of the product, and
the decision means further decides the delivery size based on the weight.

### Supplementary Note 7

The POS terminal according to any one of Supplementary Notes 4 to 6, further including
a settlement means for performing settlement processing of a delivery fee relevant to the delivery size.

### Supplementary Note 8

The POS terminal according to any one of Supplementary Notes 4 to 6, further including
an output means for outputting information regarding the delivery size.

### Supplementary Note 9

A control method including:
acquiring an image of a placed product;
determining whether processing to be executed is settlement processing of the product or decision processing of a delivery size of the product based on the image; and
switching to a mode according to a determination result.

### Supplementary Note 10

A program for causing a computer to execute:
acquiring an image of a placed product;
determining whether processing to be executed is settlement processing of the product or decision processing of a delivery size of the product based on the image; and
switching to a mode according to a determination result.

### Supplementary Note 11

A recording medium having stored therein a program for causing a computer to execute:
acquiring an image of a placed product;
determining whether processing to be executed is settlement processing of the product or decision processing of a delivery size of the product based on the image; and
switching to a mode according to a determination result.

Some or all of the configurations described in Supplementary Notes 2 to 8 dependent on the above-described Supplementary Note 1 can also be dependent on Supplementary Notes 9 to 11 by the dependency relationship similar to that of Supplementary Notes 2 to 8. Furthermore, some or all of the configurations described as the Supplementary Notes can be similarly dependent on not only the Supplementary Notes 1, and 9 to 11, but also various pieces of hardware and software, and various recording devices or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A point of sales (POS) terminal comprising:
one or more memories storing instructions; and
one or more processors configured to execute the instructions to:
acquire an image of a placed product;
determine whether processing to be executed is settlement processing of the product or decision processing of a delivery size of the product based on the image; and
switch to a mode according to a determination result.

2. The POS terminal according to claim 1,
wherein the at least one processor is further configured to execute the instructions to:
identify a type of the product based on the image,
determine the processing based on the type.

3. The POS terminal according to claim 2,
wherein the at least one processor is further configured to execute the instructions to:
measure a weight of the product,
determine the processing based on the weight.

4. The POS terminal according to claim 1,
wherein the at least one processor is further configured to execute the instructions to:
switch to a delivery size decision mode in a case where the processing is decision processing of a delivery size of the product.

5. The POS terminal according to claim 4,
wherein the at least one processor is further configured to execute the instructions to:
measure a size of the product based on the image; and
decide the delivery size based on the size in the delivery size decision mode.

6. The POS terminal according to claim 5,
wherein the at least one processor is further configured to execute the instructions to:
measure a weight of the product, and
decide the delivery size based on the weight.

7. The POS terminal according to claim 4,
wherein the at least one processor is further configured to execute the instructions to:
perform settlement processing of a delivery fee relevant to the delivery size.

8. The POS terminal according claim 4,
wherein the at least one processor is further configured to execute the instructions to:
output information regarding the delivery size.

9. A control method comprising:
acquiring an image of a placed product;
determining whether processing to be executed is settlement processing of the product or decision processing of a delivery size of the product based on the image; and
switching to a mode according to a determination result.

10. A non-transitory recording medium having stored therein a program for causing a computer to execute:
acquiring an image of a placed product;
determining whether processing to be executed is settlement processing of the product or decision processing of a delivery size of the product based on the image; and
switching to a mode according to a determination result.
